(19) United States
(12) Patent Application Publication
(10) Pub. No.: US 2026/0340373 A1
(43) Pub. Date: Oct. 29, 2026

(54) COMPUTATION STABILITY TRACKING USING DATA ANCHORS FOR FIBER RAYLEIGH-BASED NONLINEAR RANDOM PROJECTION SYSTEM

(71) Applicant: NEC Laboratories America, Inc., Princeton, NJ (US)

(72) Inventors: Giacomo Borraccini, Plainsboro, NJ (US); Yue-Kai Huang, Princeton, NJ (US); Shaobo Han, Princeton, NJ (US)

(21) Appl. No.: 19/634,835

(22) Filed: Mar. 31, 2026

Related U.S. Application Data
(60) Provisional application No. 63/794,471, filed on Apr. 25, 2025.

(51) Int. Cl. G06N 3/067; G02F 1/365; G06E 3/00; G06N 3/063

(52) U.S. Cl. CPC G06N 3/067; G02F 1/365; G06E 3/006; G06N 3/063

(57) ABSTRACT

A system and method track computation stability in fiber Rayleigh-based nonlinear random projection systems. The system inserts fixed data anchors into a modulated data stream injected into an optical fiber. Rayleigh backscattering acts as a randomly structured transfer matrix. A digital kernel monitor correlates computed results of the fixed data anchors from different time instances to detect physical drift in the Rayleigh transfer function. When correlation drops below a threshold, the system initiates an algorithmic manifold augmentation process. This process extracts the drifted anchor responses, calculates a localized loss metric, and applies a constrained gradient descent to update a specific subset of weights in a backend digital neural network without catastrophic forgetting or retraining the entire model.

### CROSS REFERENCE TO RELATED APPLICATIONS

This application claims the benefit of U.S. Provisional Patent Application Ser. No. 63/794,471 filed Apr. 25, 2025, the entire contents of which is incorporated by reference as if set forth at length herein.

### FIELD OF THE INVENTION

The present invention relates generally to optical computing and machine learning architectures. More specifically, the present invention relates to tracking computation stability and maintaining accuracy of analog photonic computation kernels utilized for nonlinear random projections.

### BACKGROUND OF THE INVENTION

Nonlinear random projections offer an elegant bridge between high-dimensional data and efficient computation. By mapping signals to a lower-dimensional space with carefully chosen randomness, they preserve geometric structure for tasks such as dimensionality reduction and compressed sensing. This operation is commonly implemented for the first few layers of machine learning models, such as deep neural networks (DNNs), to handle heavy front-end computational workloads.

Migrating these operations from digital electronics to analog photonics allows systems to harness optical properties—specifically Rayleigh backscattering in optical fibers—to realize random kernels that scale naturally with fiber length. This provides significant adaptability and energy efficiency, requiring only lightweight digital processing downstream for classification, compression, or denoising.

However, maintaining the computation accuracy and stability of these implemented analog models remains a significant challenge. For Rayleigh-based random projection, the computation kernels are highly susceptible to environmental factors, such as temperature drifts and ambient vibrations. Furthermore, frequency drift of optical lasers plays a critical role in computation stability. Prior art demonstrates that computation results can deviate on the order of seconds, even when utilizing lasers with kilohertz-level linewidths. In its current form, assuming a fixed model for Rayleigh-based nonlinear random projection is unrealistic. Therefore, a need exists in the art for a method to continuously track the state of computation kernels to enable continuous model updates without complete retraining.

### SUMMARY OF THE INVENTION

The following presents a simplified summary of one or more embodiments in order to provide a basic understanding of such embodiments. This summary is not an extensive overview of all contemplated embodiments and is not intended to either identify key or critical elements of all embodiments or delineate the scope of any or all embodiments.

In one aspect, a system for computing nonlinear random projections comprises an optical hardware front-end and a digital processing back-end. The system is configured to use a fraction of a modulated data stream to insert fixed anchors for computation stability monitoring. The fixed anchors act as a probing signal applied concurrently to sense the drift in a random matrix kernel generated by fiber Rayleigh backscattering. A processor correlates the anchors after computation at different time instances to determine whether a digital training model requires calibration via a manifold augmentation method.

In another aspect, a method is provided for dynamically calibrating a digital decoder neural network in a hybrid optical-digital computation system. The method identifies physical drift in optical responses to fixed data anchors and executes a targeted manifold augmentation process. This process updates a subset of neural network weights using a constrained gradient descent based on the drifted anchor responses, thereby bypassing the need to retrain the entire model.

### BRIEF DESCRIPTION OF THE DRAWING

FIG. 1 is a schematic, conceptual block diagram of an illustrative hybrid computation system with Rayleigh-based nonlinear projection showing data signal flow according to aspects of the present invention. Since the heavy computation load is done optically in fiber, only a lightweight backend neural network is required in digital processing. The weights of the backend NN need to be calibrated based on the change in the Rayleigh impulse response using data anchors.

FIG. 2 is a schematic flow diagram illustrating the insertion of fixed anchors within a data sequence to monitor the stability of a Rayleigh transfer function according to aspects of the present invention.

FIG. 3 illustrates the application of the Rayleigh-based nonlinear random projection for MNIST image reconstruction and compression according to aspects of the present invention.

FIG. 4(A) shows peak signal-to-noise ratio and structural similarity index measure between original and processed compressed image results for different compression ratios; and FIG. 4(B) shows schematic output image(s) after the digital decoder at different compression ratio(s) according to aspects of the present invention.

FIG. 5 illustrates correlation results for data anchors captured at different time instances including root mean-square error and cross-correlation lag according to aspects of the present disclosure.

FIG. 6 is a schematic block diagram illustrating a computer system on which aspects or methods of the present invention may be implemented/executed and/or incorporated into a controller or other system according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

Unless otherwise explicitly specified herein, the FIGs comprising the drawing are not drawn to scale.

By way of some additional background, we note that nonlinear random projections offer an elegant bridge between high dimensional data and efficient computation: by mapping signals to a lower dimensional space with carefully chosen randomness, they preserve geometric structure for tasks such as dimensionality reduction and compressed sensing. It is commonly implemented for the first few layers of machine learning models such as deep neural networks (DNN) or sparse signal recovery using graphic processing units (GPUs), as the computation loads can get very intensive when the input data size is large. By migrating the operations from digital electronics to analog photonics, there is potential power savings to be gained by harnessing optical properties—Rayleigh back scattering in optical fibers, for instance—to realize random kernels that scale naturally with fiber length. By using optical fiber as an all-optical encoder to handle the heavy front end workload with the built-in kernels for random projections, computation adaptability and energy efficiency can be achieved as only lightweight digital processing is needed downstream for classification, compression, or denoising.

Even though analog photonics can reduce power consumption, challenges remain on how to maintain the computation accuracy and stability of the implemented model. For Rayleigh based random projection, the computation kernels can be affected by environmental factors such as temperature drifts and ambient vibrations. Furthermore, frequency drift of the optical lasers also plays an important role in computation stability, with prior art showing that computation results can deviate on the order of seconds even with ~kHz level laser linewidth. At its current form, it is unrealistic to assume a fixed model for Rayleigh-based nonlinear random projection. Thus, a method is required to keep track of the state of the computation kernels for continued model update.

As we shall show and describe, to combat the computation result drifting issue caused by the changes in fiber Rayleigh response, we use a tiny fraction of the modulated data stream to insert fixed anchors for computation stability monitoring. The fixed anchors acted a probing signal applied to concurrently “sense” the drift in the random matrix kernel, and we can use the correlation of the anchors after computation at different time instances to determine whether the digital training model needs to be calibrated by manifold augmentation method. Thus, we then apply continuous update to the digital decoder via manifold augmentation when the coefficients in the Raleigh-based nonlinear random projection is impacted by environment or laser frequency drift.

### System Architecture

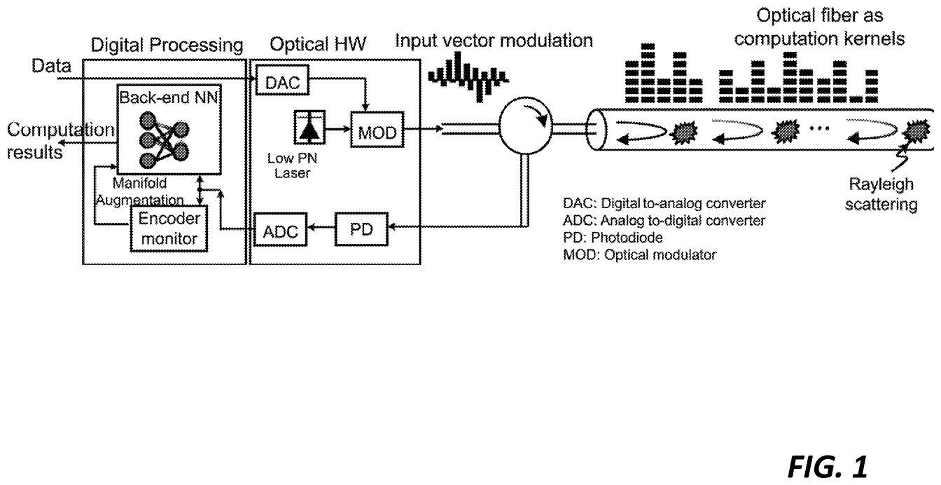

FIG. 1 is a schematic, conceptual block diagram of an illustrative hybrid computation system with Rayleigh-based nonlinear projection showing data signal flow according to aspects of the present invention. Since the heavy computation load is done optically in fiber, only a lightweight backend neural network is required in digital processing. The weights of the backend NN need to be calibrated based on the change in the Rayleigh impulse response using data anchors.

As illustrated in FIG. 1, the inventive hybrid computation system executes the nonlinear random projection for the front-end computation exclusively using a fiber Rayleigh response. In this platform, only a lightweight back-end neural network is implemented to produce final computation results.

To perform computation optically, data is encoded into temporal sequences by applying amplitude modulation using an optical modulator. A low phase noise laser, possessing a linewidth of less than 1-kHz, is utilized for optical encoding to suppress the temporal drift of the fiber Rayleigh impulse response. The amplitude-modulated temporal data sequences are injected into an optical fiber. The resulting Rayleigh backscattered signal operates as a convolution between the input vector and the complex Rayleigh transfer function, sampled at the modulation rate of the input signal. Distributed Rayleigh backscattering along the fiber thus acts as a randomly structured transfer matrix applied to the input vector. By performing direct detection on the reflected optical signal using a photodiode, the setup achieves a nonlinear function, as the converted electrical signal is the square of the input optical signal.

Stability Monitoring with Data Anchors

Due to fluctuations in ambient temperature and laser frequency, the complex Rayleigh transfer function drifts over time. To monitor this drift, the system uses a limited portion of the modulated data stream to insert fixed anchors repeatedly after a preset time duration. These fixed anchors act as a probing signal to sense changes in the matrix coefficients. A digital kernel monitor correlates the computed matrix-vector multiplication results of the anchors from two different time instances.

The time duration between inserted anchors depends on variations of the fiber environment and laser stability. The duration is set so adjacent computed results maintain high correlations, specifically >0.9, between them. With a kHz-level linewidth laser in a relatively quiet and temperature-controlled environment, anchors comprising a size of 10 images are applied every 80 ms.

### Model Calibration Via Manifold Augmentation

When the correlation peak value drops to a predefined threshold, it acts as a trigger to initiate manifold augmentation. This process adjusts the weights of the digital back-ends using the data anchors, updating the backend neural network when the Rayleigh response maintains partial correlation, successfully bypassing the need to retrain a whole new model.

### Algorithmic Implementation of Manifold Augmentation

To fully enable the calibration of the digital decoder model, the present invention utilizes a continuous fine-tuning algorithm. The physical optical kernel acts as a time-variant projection matrix Hₜ. The digital back-end neural network comprises weight matrices W.

At an initial time t₀, the system is fully trained, and baseline optical responses for a set of fixed input data anchors X_{anchor} are recorded as Y_{anchor}(t₀)=Ht₀ X_{anchor}. Over time, as environmental factors induce drift, the physical projection matrix changes to Hₜ, and the system records the drifted optical responses as Y_{anchor}(t)=Hₜ X_{anchor}.

When a correlation metric (e.g., cross-correlation peak ρₘₐₓ) between Y_{anchor}(t₀) and Y_{anchor}(t) falls below a predefined threshold, the processor executes the following algorithmic steps to calibrate the decoder weights W:

Anchor Extraction and State Capture: The processor isolates the drifted optical responses Y_{anchor}(t) from the continuous digital data stream.

Augmented Dataset Construction: The system constructs a localized calibration batch by pairing the drifted optical anchor responses Y_{anchor}(t) with their corresponding, known ground-truth targets Zₜᵣᵤₑ.

Forward Propagation and Loss Calculation: The processor executes a forward pass of the drifted anchor responses Y_{anchor}(t) through the current state of the digital decoder (having weights Wₜ₋₁) to generate predicted outputs \hat{Z}:

\hat{Z}=f(Wₜ₋₁,Y_{anchor}(t))

The system calculates a loss function £ (e.g., Mean Squared Error) between the predictions and the ground-truth targets:

$$ℒ = \frac{1}{N} {\sum }_{i = 1}^{N} {( {\hat{Z}}_{i} - {Z}_{true , i} )}^{2}$$

where N is the number of data anchors.

Partial Weight Update via Gradient Descent: To prevent catastrophic forgetting of broader dataset features not represented in the small anchor subset, the processor applies a constrained gradient descent. The system freezes the weights of deeper layers and calculates the gradient of the loss ∇_{W}£ exclusively with respect to the first hidden layer weights, updated using a predefined learning rate η:

Wₜ=Wₜ₋₁−η∇w£

Iteration and Resumption: Step 4 (the partial weight update) is iterated for a limited number of epochs until the localized loss £ converges below a secondary acceptable threshold. The updated weights Wₜ are committed to the decoder, and the system resumes standard inference on the non-anchor data stream.

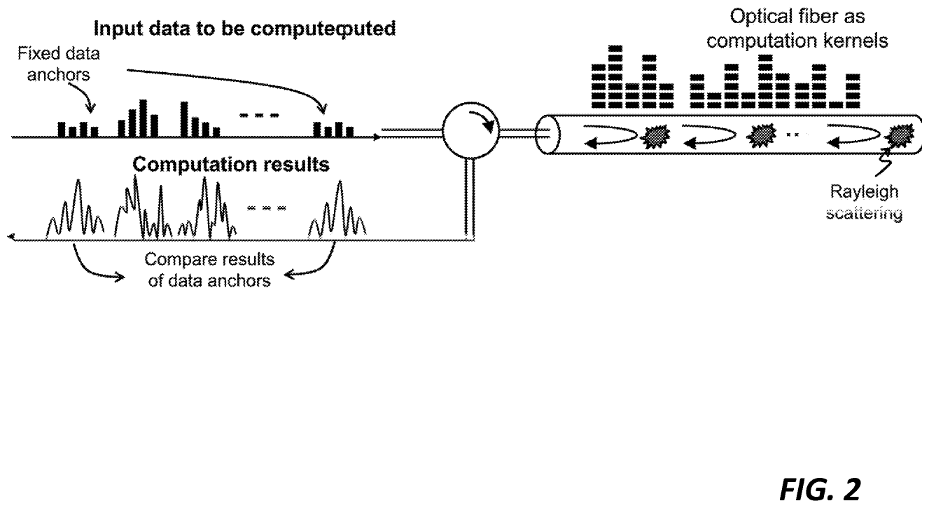

FIG. 2 is a schematic flow diagram illustrating the insertion of fixed anchors within a data sequence to monitor the stability of a Rayleigh transfer function according to aspects of the present invention.

As illustratively shown and noted, due to fluctuation of ambient temperature and laser frequency, the complex Rayleigh transfer function will also drift over time. In our invention, we propose to use a small portion of the input data sequence to insert fixed anchors, as shown in the figure. As this portion of data is fixed, we can use the computation results from the optical fiber to determine the amount of drift in the Rayleigh transfer function. In our implementation, we use a digital kernel monitor to correlate the computed results of the anchors from two different instances, and use the correlation level to determine whether a coefficient update for the backend NN is required using manifold augmentation.

### Exemplary Embodiment: Image Reconstruction

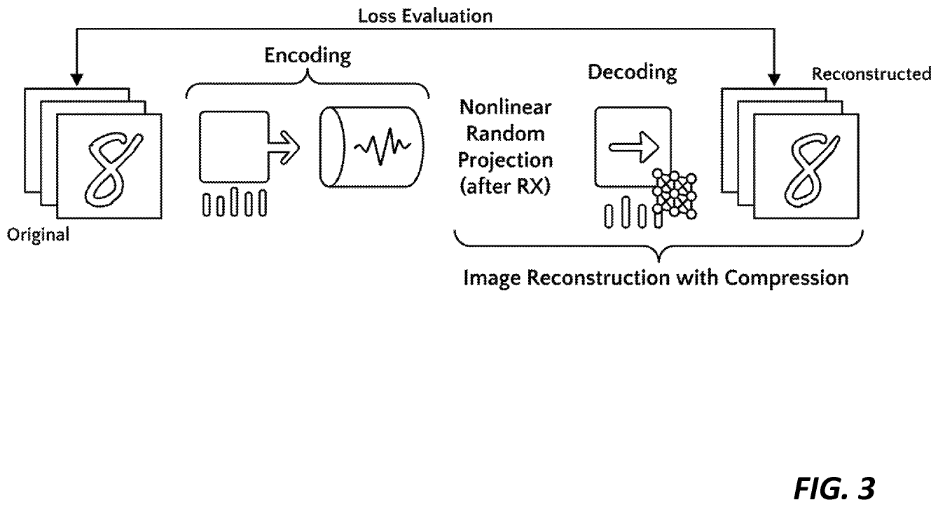

FIG. 3 illustrates the application of the Rayleigh-based nonlinear random projection for MNIST image reconstruction and compression according to aspects of the present invention.

As shown in that figure, an exemplary embodiment applies Rayleigh-based nonlinear random projection for MNIST image compression and reconstruction. A subset of 5,000 grayscale images, each 28×28 pixels with 8 bits of information, was utilized. Amplitude modulation was applied at 1-Gsps using an arbitrary waveform generator with 28 amplitude levels to encode each image into 784 symbols. Zero padding of the same length was added, resulting in 1568 symbols per image, ensuring Rayleigh convolution results of consecutive images did not interfere with each other.

A 50-meter fiber length was used, and computed results were converted to the digital domain using direct detection with a photodiode bandwidth of 500-MHz.

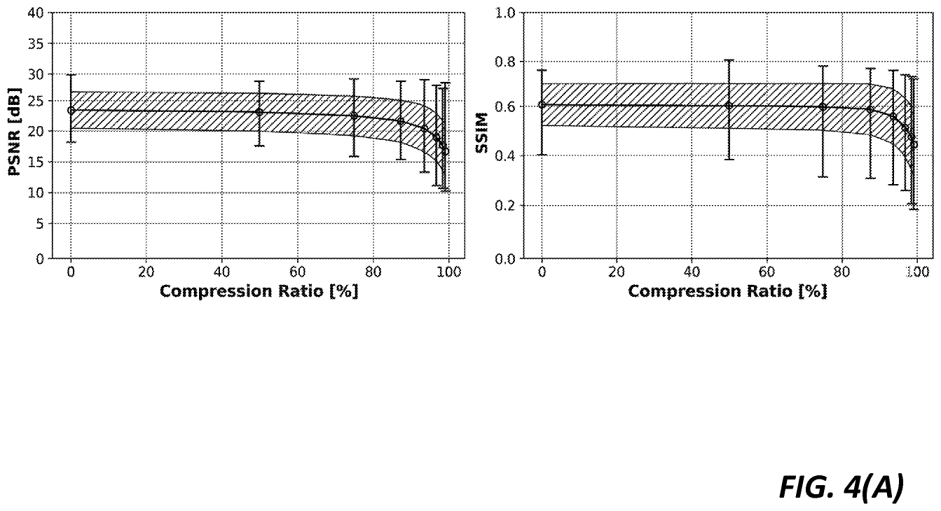

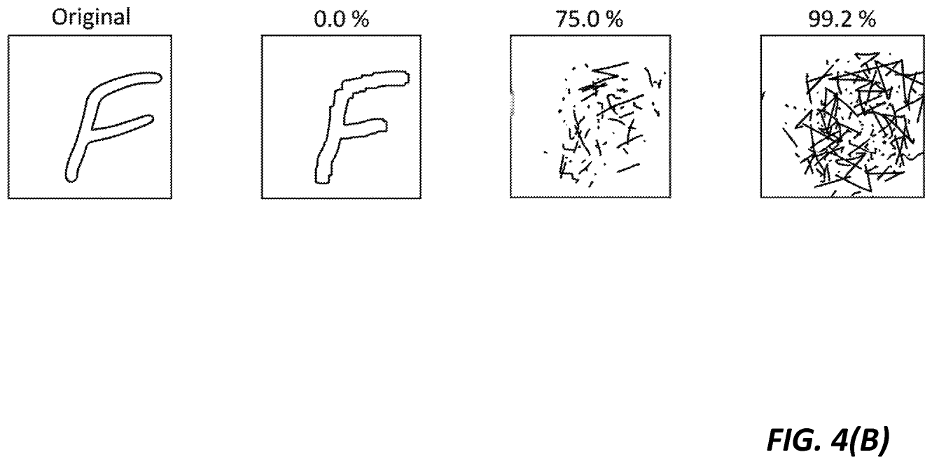

FIG. 4(A) shows peak signal-to-noise ratio and structural similarity index measure between original and processed compressed image results for different compression ratios; and FIG. 4(B) shows schematic output image(s) after the digital decoder at different compression ratio(s) according to aspects of the present invention.

As shown in these figures, the system maintained an average peak signal-to-noise ratio (PSNR) above 15-dB even after 99.2% compression.

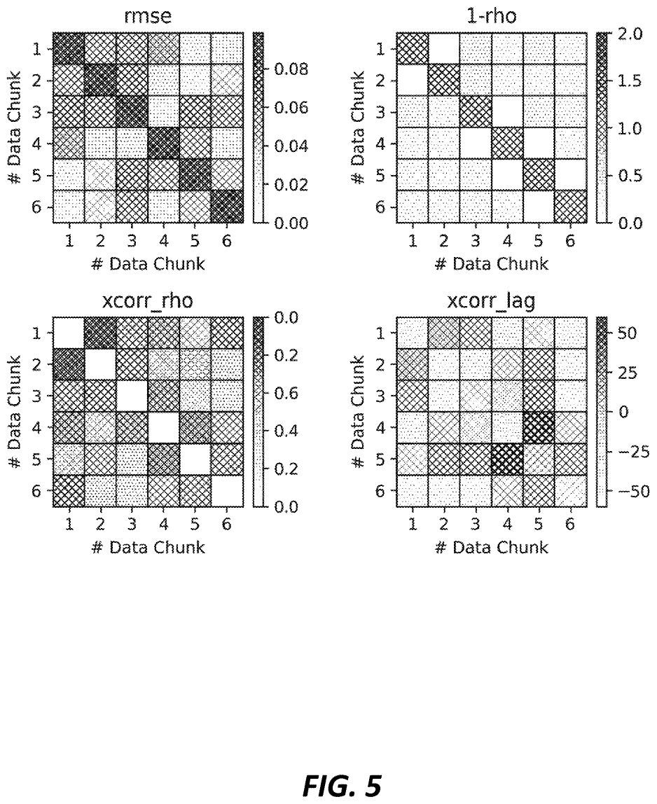

FIG. 5 illustrates correlation results for data anchors captured at different time instances including root mean-square error and cross-correlation lag, used to trigger the manifold augmentation to calibrate the decoder, according to aspects of the present disclosure.

### Discussion

For machine learning tasks utilizing fiber Rayleigh effects for nonlinear random projection, the back-end digital processing can be lightweight. However, the overall model accuracy will drop if the Rayleigh backscatter coefficients changes over time. The main feature of our invention is providing a method to continuously monitor the change in the fiber Rayleigh impulse response, which was used as the matrix coefficients in nonlinear random projection operation. Instead of retraining the digital backend for a whole new model after the Rayleigh response has significantly drifted, we use manifold augmentation to update the backend NN when the Rayleigh response still maintains partial correlation, but the monitored change has reached a certain threshold.

To monitor the change in Rayleigh kernel coefficients over time, we use a limited portion in the modulated data stream to insert fixed anchors repeatedly after a preset time duration. The retrieved matrix-vector multiplication results via Rayleigh backscattering of the anchors from different time instances can be correlated to infer the change in the Rayleigh scattering coefficients. When the correlation peak value has dropped to a certain set threshold, it will act as a trigger to initiate manifold augmentation by adjusting the weights of the digital back-ends using the data anchors.

The time duration between each inserted anchors is dependent on the variations of the fiber environment and the laser stability. The duration should be set so that adjacent computed results still have high correlations (>0.9) between them. With kHz-level linewidth laser, relative quiet and temperature-controlled environment, we applied anchors with size of 10 images for every 80 ms.

Using anchors to calibrate the backend decoder for a MNIST image compressor using Rayleigh based nonlinear random projection, we successfully achieved high image reconstruction fidelity even with temporal drift in the Rayleigh transfer function. The proposed solution shows excellent compression capabilities, suggesting the possibility to reduce power consumptions and memory (a few input data and smaller decoder), and speed up the computation (faster inference).

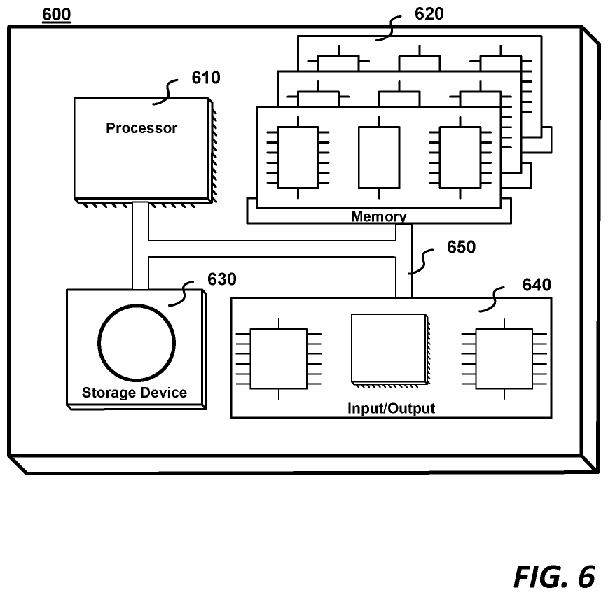

FIG. 6 is a schematic block diagram illustrating a computer system on which aspects or methods of the present invention may be implemented/executed and/or incorporated into a controller or other system according to aspects of the present disclosure.

With reference to that FIG. 6, there it shows an illustrative computer system, 600 suitable for implementing methods and systems according to an aspect of the present disclosure. As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 600 as stored program control instructions.

Computer system 600 includes processor 610, memory 620, storage device 630, and input/output structure 640. One or more input/output devices may include a display. One or more busses 650 typically interconnect the components, 610, 620, 630, and 640. Processor 610 may be a single or multi core. Additionally, the system may include accelerators etc further comprising the system on a chip.

Processor 610 executes instructions in which embodiments of the present disclosure may comprise steps described in one or more of the Drawing figures. Such instructions may be stored in memory 620 or storage device 630. Data and/or information may be received and output using one or more input/output devices.

Memory 620 may store data and may be a computer-readable medium, such as volatile or non-volatile memory. Storage device 630 may provide storage for system 600 including for example, the previously described methods. In various aspects, storage device 630 may be a flash memory device, a disk drive, an optical disk device, or a tape device employing magnetic, optical, or other recording technologies.

Input/output structures 640 may provide input/output operations for system 600.

At this point, those skilled in the art will understand that while we have presented our inventive concepts and description using specific examples, our invention is not so limited. Accordingly, the scope of our invention should be considered in view of the following claims.

1. A system for computation stability tracking in optical processing, comprising:
an optical front-end configured to encode a data stream into an optical signal, the data stream including input data and a plurality of fixed data anchors;
an optical fiber configured to receive the optical signal and output a Rayleigh backscattered signal representing a nonlinear random projection of the data stream;
a detector configured to convert the Rayleigh backscattered signal into digital computation results;
and a digital back end comprising a processor configured to:
correlate the digital computation results corresponding to the fixed data anchors from a first-time instance and a second time instance; and
trigger a manifold augmentation process to update a digital decoder model when the correlation reaches a predefined threshold.

2. The system of claim 1, wherein the optical front-end comprises a laser having a linewidth of less than 1-kHz to suppress temporal drift of a fiber Rayleigh impulse response.

3. The system of claim 1, wherein the fixed data anchors are inserted repeatedly into the data stream after a preset time duration of between 10 milliseconds and 100 milliseconds.

4. The system of claim 1, wherein the correlation is evaluated using a cross-correlation peak value, and the predefined threshold is a cross-correlation peak value dropping below 0.9.

5. The system of claim 1, wherein the digital decoder model is updated via the manifold augmentation process utilizing a constrained gradient descent.

6. The system of claim 1, wherein the data stream further comprises zero padding added to temporal sequences to prevent consecutive data interference.

7. The system of claim 1, wherein the detector is a photodiode configured to perform direct detection to achieve a nonlinear function corresponding to a square of the optical signal.

8. A method for dynamically calibrating a digital decoder neural network in a hybrid optical-digital computation system, the method comprising:
receiving, by one or more processors, a first set of digital responses corresponding to a set of fixed data anchors at an initial time;
receiving, by the one or more processors, a second set of digital responses corresponding to the set of fixed data anchors at a subsequent time, wherein the second set of digital responses exhibits a physical drift relative to the first set of digital responses;
determining that a correlation metric between the first set of digital responses and the second set of digital responses falls below a predefined threshold; and
in response to the determining, executing a manifold augmentation process to update a plurality of weights of the digital decoder neural network, wherein executing the manifold augmentation process comprises:
constructing a localized calibration dataset by pairing the second set of digital responses with corresponding known ground-truth targets;
executing a forward propagation of the second set of digital responses through the digital decoder neural network to generate predicted outputs;
calculating a loss metric between the predicted outputs and the corresponding known ground-truth targets; and
applying a constrained gradient descent to update a first subset of the plurality of weights based on the calculated loss metric while freezing a second subset of the plurality of weights.

9. The method of claim 8, wherein the first set of digital responses and the second set of digital responses are physical projections derived from passing an amplitude-modulated optical signal through an optical fiber having a time-variant Rayleigh transfer function.

10. The method of claim 8, wherein the digital decoder neural network comprises a plurality of hidden layers, and wherein applying the constrained gradient descent comprises updating only weights associated with a first hidden layer while freezing weights associated with subsequent deeper layers to prevent catastrophic forgetting.

11. The method of claim 8, wherein executing the manifold augmentation process is iterated for a limited number of epochs until the calculated loss metric converges below a secondary acceptable threshold.

12. The method of claim 8, further comprising committing the updated first subset of the plurality of weights to the digital decoder neural network and subsequently resuming standard inference on a continuous, non-anchor data stream.

13. The method of claim 8, wherein the known ground-truth targets comprise original pixel values of an uncompressed image sequence corresponding to the fixed data anchors.

14. The method of claim 8, wherein the loss metric is calculated as a mean squared error between the predicted outputs and the corresponding known ground-truth targets.

15. A non-transitory computer-readable medium storing instructions that, when executed by one or more processors in a hybrid optical-digital computation system, cause the hybrid optical-digital computation system to perform operations comprising:
controlling an optical modulator to inject an amplitude-modulated optical signal into an optical fiber, wherein the amplitude-modulated optical signal encodes a continuous data stream and a periodically inserted set of fixed data anchors;
receiving, from an optical detector, a digital signal representing a nonlinear random projection of the amplitude-modulated optical signal generated via Rayleigh backscattering within the optical fiber;
monitoring a physical drift in a complex Rayleigh transfer function of the optical fiber caused by environmental or laser frequency fluctuations by extracting portions of the digital signal corresponding exclusively to the periodically inserted set of fixed data anchors at a plurality of time intervals;
calculating a cross-correlation metric between the extracted portions of the digital signal from the plurality of time intervals to quantify the physical drift; and
in response to the cross-correlation metric falling below a predefined threshold, executing a manifold augmentation algorithm to compensate for the physical drift by calculating a localized loss metric and selectively updating a first subset of weight matrices within a digital decoder neural network while freezing a second subset of weight matrices, thereby dynamically calibrating the hybrid optical-digital computation system without interrupting continuous optical modulation.

16. The non-transitory computer-readable medium of claim 15, wherein calculating the cross-correlation metric comprises calculating at least one of a root mean-square error, a shape distance, a cross-correlation peak, and a cross-correlation lag.

17. The non-transitory computer-readable medium of claim 15, wherein calculating the localized loss metric comprises calculating a mean squared error between a predicted output of the periodically inserted set of fixed data anchors and a known ground-truth target.

18. The non-transitory computer-readable medium of claim 15, wherein the instructions further cause the one or more processors to decimate a dimension of the nonlinear random projection to execute image compression.

19. The non-transitory computer-readable medium of claim 15, wherein the digital decoder neural network comprises a two-layer neural network including a hidden layer of neurons.

20. The non-transitory computer-readable medium of claim 15, wherein the instructions execute the monitoring and calibrating continuously to allow a decoder to process data dynamically without interrupting an encoding phase.
